(19) United States
(12) Patent Application Publication
(10) Pub. No.: US 2008/0247108 A1
(43) Pub. Date: Oct. 9, 2008

(54) Load drive device

(75) Inventors: Akira Ando, Nagoya-city (JP); Satoshi Yoshimura, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/068,768

(22) Filed: Feb. 12, 2008

(30) Foreign Application Priority Data
Apr. 3, 2007 (JP) 2007-97355
Sep. 18, 2007 (JP) 2007-240908

(51) Int. Cl. H02H 3/00

(52) U.S. Cl. 361/84

(57) ABSTRACT

A load drive device is provided for outputting a control signal to a driving transistor and for driving a load by switching, the driving transistor and the load being connected in series between a direct current power source and ground. The load drive device includes a reverse connection protection unit which is provided in a line leading from a negative side of the direct current power source, and which blocks a current flowing therethrough when the direct current power source is connected in reverse. A failure detection is performed by a failure detection process by monitoring a change of a current flowing via the reverse connection protection unit during the driving transistor is in a conduction state.

### CROSS REFERENCE TO RELATED APPLICATION

The present application is based on Japanese Patent Applications No. 2007-97355 filed on Apr. 3, 2007 and No. 2007-240908 filed on Sep. 18, 2007, the disclosure of which are incorporated herein by reference.

### FIELD OF THE INVENTION

The present invention relates to a device for outputting a control signal to a transistor and for driving a load by switching, the transistor and the load being connected in series between a direct current power source and ground.

### BACKGROUND OF THE INVENTION

It is sometimes necessary to protect an electronic circuit, an electronic device or the like from reverse connection of a battery, with regard to a device which is mounted to a vehicle and which operates on a power source such as a battery for instance. FIG. 7 shows an exemplary configuration for protection from the reverse connection of a battery. The configuration is described as follows. A battery 1 is coupled with a series circuit that includes a fuse 2 and a Zener diode 3. A control circuit 4 is coupled with both ends of the Zener diode 3. Electricity is configured to be supplied to the control circuit 4. In the above configuration, when the battery 1 is connected in reverse, a large current flows through the Zener diode 3, and then, due to blown out of the fuse 2, electric connection is interrupted. In the above case, exchanging the fuse 2 is required every time the fuse 2 is blown out.

U.S Patent Application Publication No. 2002/0047636, corresponding to Japanese Patent Application Publication No. H10-315849, discloses a configuration for protection from the reverse connection of a battery. The configuration is shown in FIG. 8, which is described as follows. An n-channel MOSFET (metal-oxide-semiconductor field-effect transistor) 5 is provided in a line leading from the negative side of a battery 1. A gate of the FET 5 is coupled with a line leading from the positive side of the battery 1 via a resistor 6. The gate of the FET 5 is also coupled with the line leading from the negative side of the battery 1 via a capacitor 7. In the above case, when the battery 1 is connected in reverse, the FET 5 is switched off, and thereby, the protection from the reverse connection of a battery is achieved. When the battery 1 is correctly connected, the FET 5 is in an ON state.

### SUMMARY OF THE INVENTION

An object of the present invention is to provide a load drive device.

According to a first aspect of the present invention, a load drive device is provided for outputting a control signal to a driving transistor and for driving a load by switching, the driving transistor and the load being connected in series between a direct current power source and ground. The load drive device comprises a reverse connection protection unit which is provided in a line leading from a negative side of the direct current power source, and which blocks a current flowing therethrough when the direct current power source is connected in reverse with a polarity of the direct current source being reversed. The load drive device performs a failure detection process by monitoring a change of a current flowing via the reverse connection protection unit during the driving-transistor is in a conducting state.

According to the above load drive device, the reverse connection protection unit is provided in the line leading from the negative side of the direct current power source. The load drive device performs the failure detection process by monitoring the change of a current flowing via the reverse connection protection unit during the driving transistor is in the conduction state. During the driving transistor is in the conduction state, the current flows through the reverse connection protection unit, and thus, the load drive device is capable of monitoring the change of a current during the driving transistor is in the conduction state. A simple configuration for the failure detection is provided.

According to a second aspect of the present invention, a load drive device is provided for outputting a control signal to a driving transistor and for driving a load by switching, the driving transistor and the load being connected in series between a direct current power source and ground. The load drive device comprises a reverse connection protection unit which is provided in a first line leading from a negative side of the direct current power source, and which blocks a current flowing therethrough when the direct current power source is connected in reverse with a polarity of the direct current source being reversed. The load drive device performs a failure detection process by monitoring an electric potential of a second line, the second line connecting a terminal of the driving transistor and a terminal of the reverse connection protection unit.

According to the above load drive device, the reverse connection protection unit is provided in the first line leading from the negative side of the direct current power source. The load drive device performs the failure detection process by monitoring the electric potential of the second line. During the driving transistor is in the conduction state, the current flows through the reverse connection protection unit, and thus, the load drive device monitors the electric potential during the driving transistor is in the conduction state. Therefore, the load drive device having a simple configuration is provided.

According to a third aspect of the present invention, a load drive device is provided for driving a load by switching a driving transistor, the load being connected in series between a positive side of a direct current power source and the driving transistor. The load drive device comprises a circuit unit which is connected in series between the driving transistor and a first line leading from a negative side of the direct current power source with the first line being coupled to ground. The load drive device further comprises a control protection unit which is coupled with the driving transistor and the circuit unit. The control protection unit is capable of switching on and off the driving transistor. The control protection unit is configured to perform a failure detection process by monitoring an electric potential of a second line connecting the circuit unit with the driving transistor.

According to the above load drive device, the control protection unit performs the failure detection process by monitoring the electric potential of the second line. During the driving transistor is switched on, a current flows through the circuit unit. During the driving transistor is switched off, a current does not flow through the circuit unit. The electric potential of the second line is configured to be smaller than an electric potential of the positive side of the direct current source during the driving transistor is switched off. The failure detection process is capable of being performed during the driving transistor is switched on and off. The load drive device having a simple configuration is provided.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic circuit diagram of a load drive device according to a first embodiment of the present invention;

FIG. 2 is a flow chart illustrating processes associated with a control protection unit according to the first embodiment;

FIG. 3 is a timing chart illustrating a case where S1-S4 processes shown in FIG. 2 are repeatedly performed;

FIG. 4 is a schematic circuit diagram of a load drive device according to a second embodiment of the present invention;

FIG. 5 is a schematic circuit diagram of a load drive device according to a third embodiment of the present invention;

FIG. 6 is a schematic circuit diagram of a load drive device according to a fourth embodiment of the present invention;

FIG. 7 is a schematic circuit diagram according to a first prior art;

FIG. 8 is a schematic circuit diagram according to a second prior art;

FIG. 9 is a schematic diagram corresponding to a case where a configuration shown in FIG. 8 is applied to a DC motor drive device; and

FIG. 10 is a timing chat showing variations of a drain voltage and a load current in the device shown in FIG. 9.

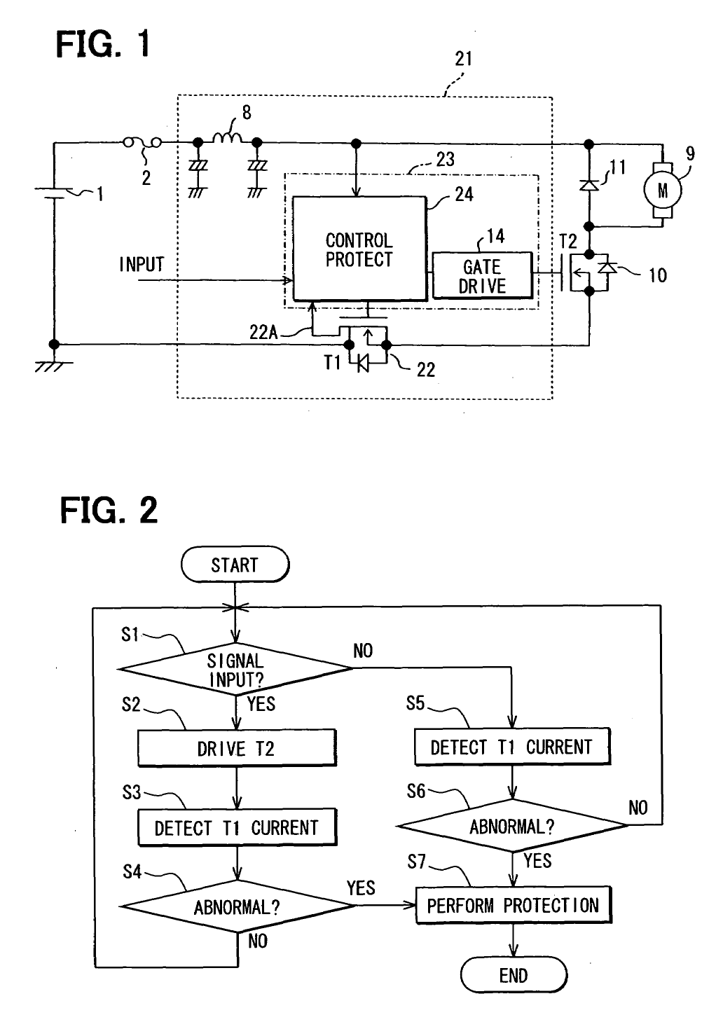

### DETAILED DESCRIPTION OF THE PREFERRED EMBODIMENTS

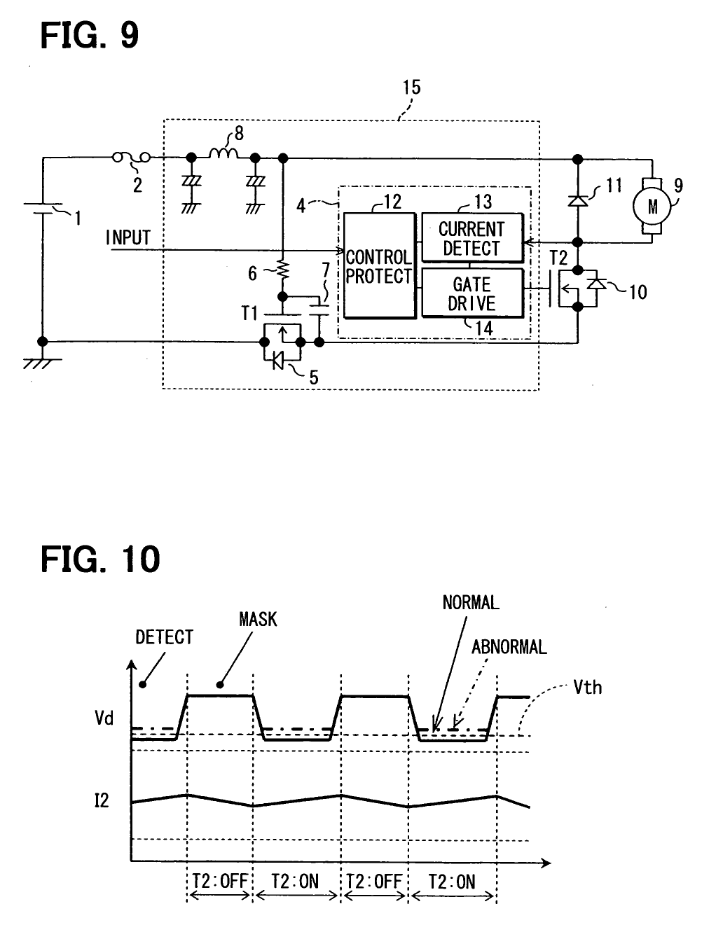

An exemplary load drive device 15 is shown in FIG. 9. The load drive device 15 drives a DC (direct current) motor 9 by PWM (pulse-width modulation) control. The load drive device 15 includes an FET 5, a π-type filter 8, a control protection unit 12, a load current detection unit 13 and a gate driving unit 14 except a battery 1, a fuse 2, an n-channel MOSFET 10 (T2) and a flywheel diode 11. A series circuit having the DC motor 9 and the FET 10 (T2) is coupled with a load side of the fuse 2 via the π-type filter 8. A source of the FET 10 is coupled with a source of the FET 5. The motor 9 and the diode 11 are connected in inverse-parallel.

A control circuit 4 includes the control protection unit 12, the load current detection unit 13 and the gate driving unit 14. The control protection unit 12 produces a PWM signal, a duty of which corresponds to a drive command signal from an ECU (electronic control unit; not shown) such as an engine ECU. When the control protection unit 12 produces the PWM signal, the PWM signal is output to a gate of the FET 10 through the gate driving unit 14. The load current detection unit 13 configured to detect a change of a load current by monitoring a drain potential of the FET 10. When the control protection unit 12 detects an abnormal load current from a detection result of the load current detection unit 13, the control protection unit 12 performs a protection process such as stop of the motor 9 etc.

When the control circuit 4 drives the motor 9 by switching based on the PWM control, a load current I2 flows through the motor 9 and the FET 10 has a drain voltage Vd. As shown in FIG. 10, the drain voltage Vd of the FET 10 varies between a voltage level of the battery 1 and a ground level in accordance with ON and OFF states of the FET 10. The ground level corresponds to the drain voltage Vd of the FET 10 determined from an ON state resistance of the FET 10 and the load current I2. When there exists an abnormality associated with the motor 9, the load current increases, and thereby, the drain voltage Vd of the FET 10 increases to a higher value than for the case of a normal state during the FET is in the ON state. Therefore, for detection of the abnormality, an abnormal state determination threshold Vth is set between the drain voltage Vd provided in the case of the normal state and that provided in the case of the abnormal state.

According to the configuration shown in FIG. 9, the drain voltage Vd increases to a power source level during the FET 10 is in the OFF state, and thus, masking detection of the load current I2 is required during the FET 10 is in the OFF state.

### First Embodiment

A load drive device 21 according to a first embodiment drives the motor 9 as a load, the motor 9 being mounted to a vehicle. In the load drive device 21, the load drive device 21 includes an n-channel MOSFET 22 as a reverse connection protection unit including a protection transistor. The MOSFET 22 has a current detection terminal 22A. The current detection terminal 22A utilizes, for example, a current mirror circuit, and is capable of detecting a current divided from a drain current of the FET 22.

The load drive device 21 includes a control circuit 23, and the control circuit 23 does not include the load current detection unit 13 shown in FIG. 9. The load drive device 21 includes a control protection unit 24 as a protection and failure detection means. The control protection unit 24 is configured to perform a protection process based on a change of a current flowing through the current detection terminal 22A of the FET 22. The control protection unit 24 is configured to cause a gate of the FET 22 to be in a low level state via its inside part when the battery 1 is connected in reverse. The control protection unit 24 is configured to perform the protection process by switching off the FET 22. A part of the control protection unit 24 may be similar to a part of the configuration described in FIG. 8.

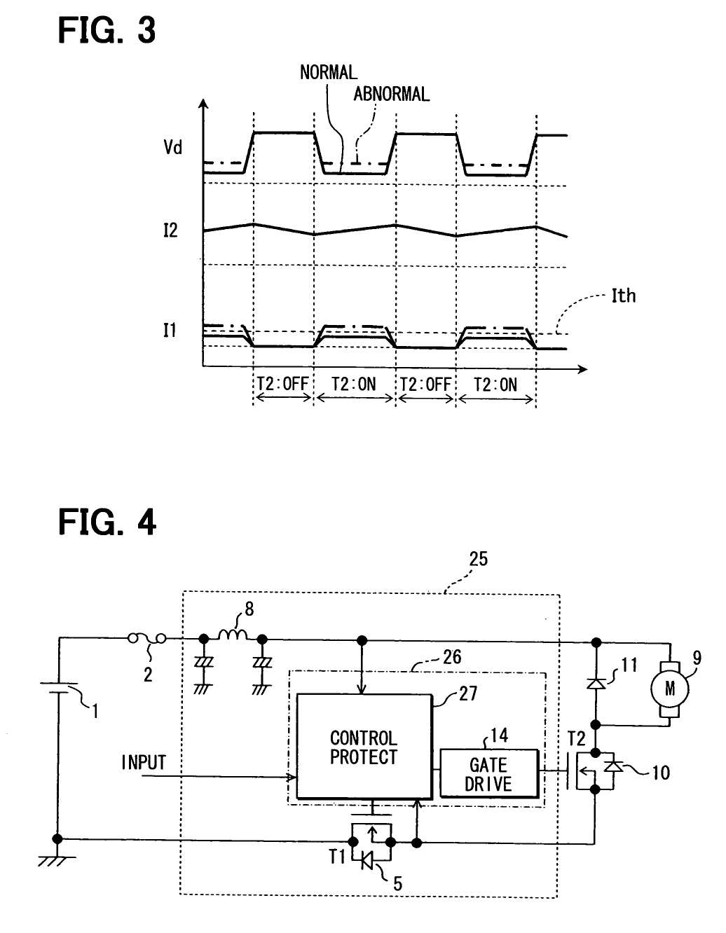

Processes performed by the load drive device 21 according to the first embodiment are described below with reference to FIG. 2 and FIG. 3. Referring to FIG. 2, during the processes are being performed, the FET 22 is maintained to be in the OFF state. The control protection unit 24 determines whether a drive command signal for driving the motor 9 is input from an external unit at S1. When the drive command signal is input, the control protection unit 24 performs an S2 process in which the control protection unit 24 performs the PWM control for driving the FET 10 (T2, a driving transistor) by switching. The control protection unit 24 detects a current flowing through the current detection terminal 22A of the FET 22 at S3. The control protection unit 24 performs a failure detection process at S4. When a failure or an abnormality is not detected, process is returned to S1. When the failure or the abnormality is detected, the control protection unit 24 performs an S7 process in which the protection process such as stop of the motor 9 for instance is performed.

When the control protection unit 24 determines at S1 that the drive command signal is not input, the control protection unit 24 performs an S5 process in which the control protection unit 24 detects a current flowing through the current detection terminal 22A of the FET 22. The control protection unit 24 determines whether there exists the abnormality or the failure at S6. Since the FET 10 is not switched when the drive command signal is not input, if a current flows through the current detection terminal 22A during the FET 22 is not switched, it is determined that the FET 10 is possibly broken due to short. For the above-described reason, a determination is made that there exists the failure (i.e., abnormality) when the current flows through the current detection terminal 22A, and then, the protection process is performed at S7.

FIG. 3 illustrates a case where the drive command signal is input and the motor 9 is driven with the processes S1-S4 being repeatedly performed. When there exists an abnormality associated with the motor 9, the T2 drain voltage Vd provided in an abnormal state (a dashed-dotted line) may be higher than that provided in a normal state (a solid line) during the FET 10 is in the ON state (T2: ON). In the above case, as shown in FIG. 3, a drain current I1 of the FET 10 becomes larger (a dashed dotted line), and accordingly, a current flowing through the current detection terminal 22A of the FET 22 increases. Therefore, a load current I2 provided in the abnormal state is capable of being detected by setting a threshold Ith (dotted line) for the current I1 flowing via the current detection terminal 22A.

According to the present embodiment, the FET 22 is provided in a line leading from the negative side of the battery 1. The FET 22 is switched on when the motor 9 is driven. The FET 22 includes the current detection terminal 22A which divides the current during the FET 22 is in the ON state. The control protection unit 24 switches off the FET 22 when the control protection unit 24 checks whether the battery 1 is connected in reverse. During the FET 10 is in the ON state, the control protection unit 24 performs the failure detection process by monitoring the change of the current flowing through the current detection terminal 22A.

Since the current flows through the FET 22 only during a period of the FET 10 being in the ON state, it is only necessary for the control protection unit 24 to monitor the change of the current during the above period. Unlike the conventional case, it is not necessary to mask the current during the failure detection process is performed. Therefore, it is possible to simplify a configuration of the control protection unit 24. Furthermore, since the control protection unit 24 can detect the abnormality if the current flows through the current detection terminal 22A, the control protection unit 24 can further detect a failure associated with the FET 10 due to, for example, short.

### Second Embodiment

As shown in FIG. 4, a load drive device 25 includes the FET 5 as the reverse connection protection unit including the protection transistor. The FET 5 may be substantially identical to that shown in FIG. 8. A control circuit 26 includes a control protection unit 27 as the protection and failure detection means. The control protection unit 27 of the control circuit 26 detects a source potential of the FET 5 instead of detecting the current flowing through the current detection terminal 22A. The source potential of the FET 5 corresponds to a voltage applied to a line connecting between the source of the FET 5 and the FET 10.

The source potential of the FET 5 is determined from an ON resistance of the FET 5 and a current flowing through the FET 5. Therefore, by monitoring a variation of the source potential of the FET 5, the load drive device 25 can perform a failure detection process which is similar to that according to the first embodiment.

In the load drive device 25, the FET 5 is provided in the line leading form the negative side of the battery 1. The control protection unit 27 performs the failure detection process by monitoring the change of the source potential of the FET 5. The load drive device 25 according to the second embodiment has a substantially same advantage as the load drive device 21 according to the first embodiment.

### Third Embodiment

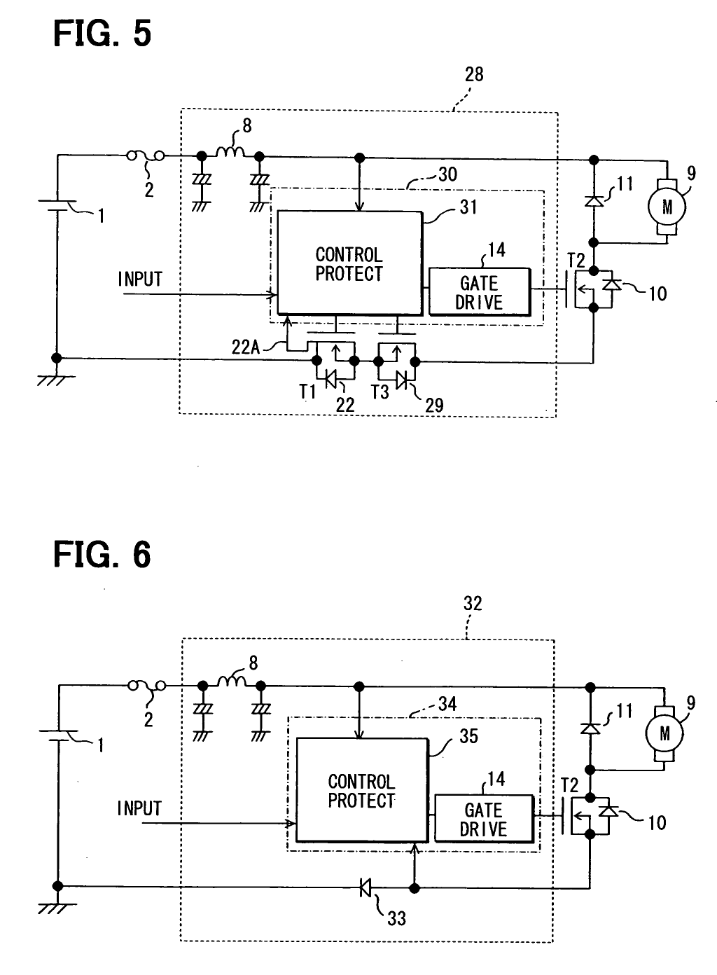

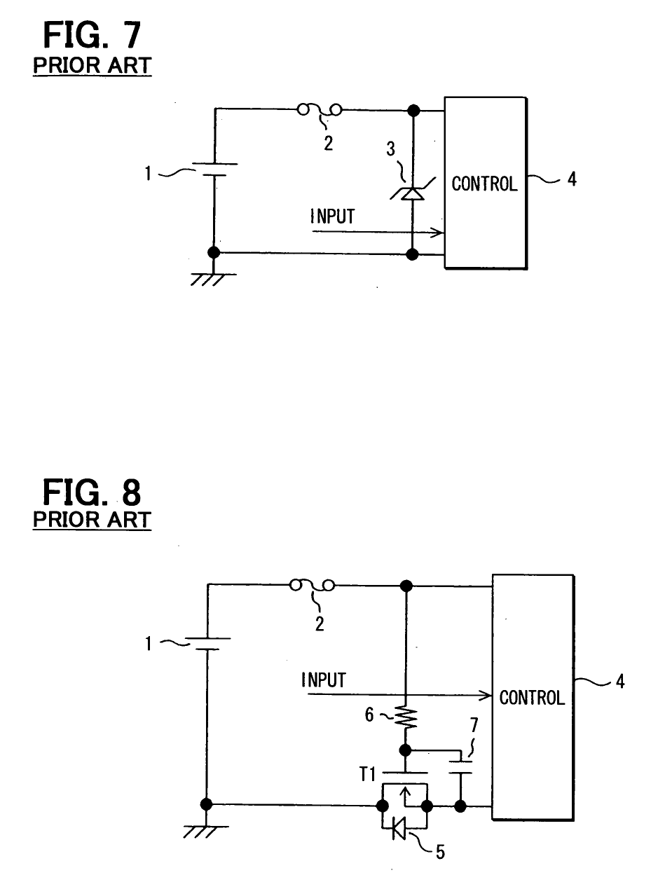

As shown in FIG. 5, a load drive device 28 includes an n-channel MOSFET 29 as the reverse connection protection unit including the protection transistor. A control circuit 30 includes a control protection unit 31 as the protection and failure detection means. The FET 22 and a n-channel MOSFET 29 is connected in series through a line leading form the negative side of the battery 1 such that a source of the FET 22 is coupled with a source of the FET 29. In a normal operating state, both of the FET 22 and the FET 29 are in an ON state. When the control protection unit 31 of the control circuit 30 makes the determination corresponding to “YES” (abnormality) at S6 shown in FIG. 2, both of the FET 22 and the FET 29 are switched off. Maintaining a flow of short-circuit current is prevented.

According to the third embodiment, when the control protection unit 31 performs a failure detection process during a period of the FET 10 being switched off, the control protection unit 31 switches off the FET 22 and the FET 29. Therefore, when the FET 10 is broken due to short, a flow of a short-circuit current is prevented. Further, reaching negative influence to another element is prevented.

### Fourth Embodiment

As shown in FIG. 6, a load drive device 32 includes a diode 33 as the reverse connection protection unit and a control protection unit as the protection and failure detection means. The control protection unit 35 of the load drive device 32 performs a failure detection process by detecting variation of an anodic potential of the diode 33.

The diode 33 is capable of blocking a current when the battery 1 is connected in reverse. Since a current flows through the diode 33 only during a period of the FET 10 being in the ON state, it is not necessary to mask a current when the failure detection process is performed, similarly to the cases of the above embodiments. The control protection unit 35 need not control an electric conduction associated with the diode 33, and simple control is provided accordingly.

While the invention has been described with reference to preferred embodiments thereof, it is to be understood that the above-described embodiments and constructions. In addition, while the various combinations and configurations, which are preferred, other combinations and configurations, including more, less or only a single element, are also within the spirit and scope of the invention.

Alternatively, the diode 33 according to the fourth embodiment may be replaced with a diode-connected bipolar transistor or a MOSFET as the reverse connection protection unit for instance. Alternatively, when the diode 33 is disposed similarly to the case of the-fourth embodiment, the failure detection process may be performed by directly detecting the current flowing through the diode 33. Alternatively, the load may be another element instead of the motor, and the load may cover any elements driven by switching and energized by a direct current. Alternatively, the switch may be another element instead of a low-side drive type element, for example a high-side drive type element such as a p-channel MOSFET may be used.

What is claimed is:

1. A load drive device for outputting a control signal to a driving transistor and for driving a load by switching, the driving transistor arid the load being connected in series between a direct current power source and ground, the load drive device comprising:
a reverse connection protection unit which is provided in a line leading from a negative side of the direct current power source, and which is configured to block a current flowing therethrough when the direct current power source is connected in reverse with a polarity of the direct current source being reversed; and
a failure detection means which performs a failure detection process by monitoring a change of a current flowing via the reverse connection protection unit during the driving transistor is in a conduction state.

2. The load drive device according to claim 1, wherein
the failure detection means performs the failure detection process when a current flows through the reverse connection protection unit during the driving transistor is in a non-conduction state.

3. The load drive device according to claim 1, further comprising:
a protection means, wherein
the reverse connection protection unit includes a protection transistor,
the protection transistor is in a conduction state when the load is driven,
the protection transistor has a current detection terminal,
the current detection terminal of the protection transistor is configured to divide a current flowing through the protection transistor when the protection transistor is in the conduction state,
the protection means switches off the protection transistor when the protection means determines that the direct current power source is connected in reverse with the polarity of the direct current source being reversed, and
the failure detection means performs the failure detection process by monitoring a change of the current flowing through the current detection terminal during the driving transistor is in the conduction state.

4. A load drive device for outputting a control signal to a driving transistor and for driving a load by switching, the driving transistor and the load being connected in series between a direct current power source and ground, the load drive device comprising:
a reverse connection protection unit which is provided in a first line leading from a negative side of the direct current power source, and which is configured to block a current flowing therethrough when the direct current power source is connected in reverse with a polarity of the direct current source being reversed; and
a failure detection means which performs a failure detection process by monitoring an electric potential of a second line, the second line connecting a terminal of the driving transistor and a terminal of the reverse connection protection unit.

5. The load drive device according to claim 4, wherein
the failure detection means performs the failure detection process when the electric potential of the second line exceeds a predetermined threshold during the driving transistor is in a non-conduction state.

6. The load drive device according to claim 4, further comprising:
a protection means, wherein
the reverse connection protection unit includes a protection transistor,
the protection transistor is switched on when the load is driven,
the protection means switches off the protection transistor when the protection means determines that the direct current power source is connected in reverse with the polarity of the direct current source being reversed.

7. The load drive device according to claim 6, wherein
the protection means switches off the protection transistor when the failure detection means performs the failure detection process during the failure detection means causes the driving transistor to be in a non-conduction state.

8. The load drive device according to claim 4, wherein
the reverse connection protection unit includes a transistor.

9. The load drive device according to claim 4, wherein
the reverse connection protection unit includes a diode.

10. A load drive device for driving a load by switching a driving transistor, the load being connected in series between a positive side of a direct current power source and the driving transistor, the load drive device comprising:
a circuit unit which is connected in series between the driving transistor and a first line leading from a negative side of the direct current power source with the first line being coupled to ground; and
a control protection unit which is coupled with the driving transistor and the circuit unit, wherein,
the control protection unit is capable of switching on and off the driving transistor, and
the control protection unit is configured to perform a failure detection process by monitoring an electric potential of a second line connecting the circuit unit with the driving transistor.

11. The load drive device according to claim 10, wherein
the circuit unit includes a reverse connection protection unit which is configured to block a current flowing therethrough when the direct current power source is connected in reverse with a polarity of the direct current source being reversed.

12. The load drive device according to claim 10, wherein
the control protection unit is configured to perform the failure detection process by monitoring the electric potential of the second line during the driving transistor is switched on and off.

13. The load drive device according to claim 11, wherein
the reverse connection protection unit includes a transistor.

14. The load drive device according to claim 11, wherein
the reverse connection protection unit includes a diode.
